(19) United States
(12) Patent Application Publication
(10) Pub. No.: US 2013/0090030 A1
(43) Pub. Date: Apr. 11, 2013

(54) COATED FIBRES, YARNS AND TEXTILES

(71) Applicants: David Van De Vyver, Lokeren (BE); Frank Godefroidt, Oudenaarde (BE); Dirk Luyckx, Oostrozebeke (BE); Laure Chaboche, Roubaix (FR); Karin Eufinger, Gent (BE); Paul Roshan, Terrassa (ES); Myriam Vanneste, Bellem (BE); Marc Van Parys, Deimle (BE); Xavier Decant, Bondue (FR); Helena Esteve Nunez, Barcelona (ES)

(72) Inventors: David Van De Vyver, Lokeren (BE); Frank Godefroidt, Oudenaarde (BE); Dirk Luyckx, Oostrozebeke (BE); Laure Chaboche, Roubaix (FR); Karin Eufinger, Gent (BE); Paul Roshan, Terrassa (ES); Myriam Vanneste, Bellem (BE); Marc Van Parys, Deimle (BE); Xavier Decant, Bondue (FR); Helena Esteve Nunez, Barcelona (ES)

(73) Assignee: DEVAN CHEMICALS NV, RONSE-RENAIX (BE)

(21) Appl. No.: 13/700,912

(22) PCT Filed: Jun. 3, 2011
(86) PCT No.: PCT/EP11/02735

§ 371 Date: Dec. 11, 2012

(30) Foreign Application Priority Data
Jun. 3, 2010 (GB) 1009276.5

(51) Int. Cl. D02G 3/44; B05D 5/12

(52) U.S. Cl. CPC D02G 3/441; B05D 5/12; Y10S 977/961; B82Y 99/00
USPC 442/111; 428/368; 428/221; 427/513; 977/961

(57) ABSTRACT

A method of treatment for synthetic or natural fibre or yarn includes coating the fibre/yarn with a dispersion of carbon nanotubes in a coating composition which is cured by actinic radiation, such as UV, to provide a flexible conductive layer on the fibre/yarn. The liquid coating composition is sheared along the direction of a long axis of the yarn as it is applied to the yarn whereby the carbon nanotubes are substantially aligned prior to curing of the coating layer to provide improved longitudinal conductance. The method provides conductive fibre/yarn, from which anti-static textiles and fabrics can be formed, by treatment of conventional fibre/yarn and in a method with low energy consumption. The improved conductance allows thin or partial (e.g. stripe) coating layers to be used for yarns which provide good feel and handle, combined with good conductivity, for textiles formed from the yarns Coating compositions for use in the method are disclosed as are anti-static yarns, fibres fabrics and textiles resulting from the method.

### TECHNICAL FIELD

The invention relates to fibres, yarns, fabrics, textiles or garments which exhibit anti-static or electrically conductive behaviour. In particular, it relates to yarns or fibres coated with an electrically conductive layer comprising carbon nanotubes dispersed within a polymer, particularly a polymer cured by actinic radiation such as visible or ultraviolet radiation. The invention is also concerned with methods for applying coatings of curable polymer comprising carbon nanotubes to textile yarns or fibres.

### BACKGROUND

Electrostatic charge on textiles typically arises from friction between two non-conductive surfaces in close contact. This phenomenon is referred to as static electricity.

Fibres and yarns used in the manufacture of textiles and fabrics generally have low electrical conductivity and hence dissipate electrostatic charges relatively slowly.

Static discharge from fabrics and textiles, particularly when worn as clothing, may be uncomfortable for the wearer and may also lead to safety hazards or damage in certain environments. For instance static discharge can cause damage to electrical components or may ignite flammable, inflammable or explosive fluids, or explosive aerosols or fine powders. For instance, in grain handling facilities, explosions due to ignition of airborne flour may be attributed to discharge of static electricity.

Increasing the rate of electrostatic charge dissipation for a textile or fabric may be achieved by increasing its electrical conductivity through the application of internal or external antistatic agents.

External or surface antistatic agents are typically directly applied as a coating to the surface layer of a textile or fabric, or to the yarns or fibres from which the textile of fabric is formed. Internal antistatic agents may be physically mixed or blended with a polymer resin during the forming operation, e.g., spinning or drawing of fibres, so that the internal antistatic agent may be uniformly distributed throughout the body of the finished product.

Man-made fibres/yarns have also been combined with conductive materials, for instance co-woven, knitted or formed into a non-woven textile with a metal or with carbon in fibre or wire form in order to improve conductivity and hence to assist in dissipation of static charge.

The addition of conductive agents into or onto fibre/yarn may lead to modification of fibre/yarn properties such as flexibility or modulus, and this may affect the feel, handle or drape of a textile prepared from the fibre/yarn. This is also the case where conductive wires are intercalated between fibres/yarns of a fabric or textile.

U.S. Pat. No. 7,060,241 discloses electrically conductive transparent films which contain carbon nanotubes. Patent application publication number JP 2008-179787 discloses a UV curable paint based on carbon nanotubes dispersed in a modified acrylic resin with a photoinitiator. Patent application publication number WO 2009/028379 discloses a coated yarn with carbon nanotubes in a polyester coating.

### SUMMARY OF THE INVENTION

It is desirable to produce anti-static fabrics and textiles which are capable of being prepared from conventional natural or synthetic yarns, which have drape, handle or feel substantially the same as conventional, non-antistatic fabrics and textiles. It is also desirable to be able to treat a conventional fibre or yarn, after it has been formed, in a simple and rapid treatment method, in order to achieve anti-static characteristics.

Hence, it is one object of the invention, amongst others, to provide a fibre or yarn which has anti-static behaviour (i.e. which is electrically conductive) derived from a conventional synthetic or natural fibre or yarn by a treatment method, so that a textile or fabric formed from the fibre or yarn does not have substantially different feel, handle or drape. It is another object of the invention to provide a method for treating the yarn to provide antistatic behaviour which is rapid and low in energy consumption. It is another object of the invention to provide a method for treating the fibre or yarn which is achievable on conventional fibre or yarn coating apparatus.

Hence, a first aspect of the invention provides a method for forming an electro-conductive yarn, the method comprising:

a) applying a liquid coating composition, comprising a resin curable by actinic radiation, to the yarn to form a liquid coating layer on the yarn, and

b) curing the liquid coating layer on the yarn with actinic radiation to form a solid coating layer on the yarn,

wherein the liquid coating composition comprises carbon nanotubes dispersed therein,

characterised in that the liquid coating composition is sheared along a direction parallel to a long axis of the yarn as it is applied to the yarn.

A second aspect of the invention provides a method for forming an antistatic textile or fabric comprising:

i) forming an electroconductive yarn by the method of the first aspect of the invention, and

ii) forming the yarn into a textile or yarn.

A third aspect of the invention provides an electroconductive yarn comprising a natural or synthetic yarn having a solid coating layer coating thereon, the solid coating layer coating comprising a photoinitiator and polymer cured by actinic radiation and carbon nanotubes, wherein the carbon nanotubes are substantially aligned with their long axes parallel to the long axis of the yarn.

In particular, the third aspect of the invention provides an electroconductive yarn obtained or obtainable by the method of the first aspect of the invention.

A fourth aspect of the invention provides an antistatic textile comprising an electroconductive yarn according to the third aspect of the invention.

### DETAILED DESCRIPTION OF THE INVENTION

Throughout this specification, the term “comprising” or “comprises” means including the component(s) specified but not to the exclusion the presence of others. The term “consisting essentially of” or “consists essentially of” means including the components specified but excludes other components except for materials present as impurities, unavoidable materials present as a result of processes used to provide the components, and components added for a purpose other than achieving the technical effect of the invention. Typically, a composition consisting essentially of a set of components will comprise less than 5% by weight, typically less than 1% by weight of non-specified components.

Whenever appropriate, the use of the term “comprises” or “comprising” may also be taken to include the meaning “consists essentially of”, “consisting essentially of” or “consists of”.

Throughout this specification, the term “yarn” is meant to include monofilaments, multifilaments, staple fibres formed into continuous fibres (also known as “bulked yarn”) and monofilaments, multifilaments or fibres spun into multifilament or multi-filament yarns.

The term “actinic radiation” means radiation capable of inducing chemical reaction. Typically this will be visible or ultraviolet radiation, but the term is not limited to these specific radiation types—for instance electron beam radiation may be used for putting the invention into effect.

The first aspect of the invention provides a method for forming an electro-conductive yarn. By electroconductive yarn it is meant that the yarn will conduct electric current whereby static electrical charge may be dissipated. For instance, the electroconductive yarn suitably has a surface resistivity of 10⁸ ohm, or less, preferably 10⁷ ohm or less, even more preferably 10⁶ ohm or less, measured with the yarn wound on a bobbin, using the Surface Resistance Meter SRM 110 produced by Wolfgang Warmbier (Germany) having an electrode geometry complying with the Standard DIN EN 100 015/1. Conditions used are otherwise as specified in EN1149-1 (June 2006). The surface resistivity (corresponding to the resistance measured between opposite sides of a square across a surface of the yarn) is derived from the surface resistance, as measured using the Surface Resistance Meter as set out above, by multiplying the measured surface resistance by a known geometric factor.

The method comprises applying a liquid coating composition, comprising a resin curable by actinic radiation, to the yarn to form a liquid coating layer on the yarn. The yarn may be any suitable natural or synthetic yarn. Natural yarns include wool, cotton, linen, silk and the like. Synthetic yarns include rayon, acrylic, polypropylene, polyester, PET, nylon and the like. As set out hereinbefore, the term yarn in this specification includes monofilament and multifilament yarns as well as spun or staple yarns.

The coating layer will typically enrobe the entire yarn, but the invention may be put into effect with a coating layer that does not entirely enrobe the yarn provided that a continuous layer of coating is put in place along the length of the yarn. For instance the coating may comprise a stripe of coating layer on one side of the yarn and extending along the length of the yarn. A yarn which is not completely surrounded or enrobed may exhibit greater flexibility than a corresponding yarn which is completely surrounded or enrobed. Hence, there is a technical advantage to partial enrobement in that the yarn may still exhibit high conductivity, but the fabric or textile form from the yarn may have softer handle or feel than if it were entirely enrobed.

Hence, the liquid coating layer may not entirely enrobe the yarn whereby the solid coating layer is a stripe of solid coating layer on the yarn extending along the yarn.

The liquid coating layer on the yarn is cured with actinic radiation to form a solid coating layer on the yarn from the curable resin. By actinic radiation is meant radiation capable of initiating or causing chemical reaction. Typically this will be ultraviolet radiation, but may, for instance, be visible radiation, electron beam radiation, ion beam radiation or the like.

The liquid coating composition comprises carbon nanotubes dispersed therein. By dispersed it is meant that the carbon nanotubes are substantially uniformly distributed through the liquid coating composition prior to its application onto the yarn.

The resin curable by actinic radiation may be selected from the group consisting of oligomers and/or monomers of acrylate and methacrylate adducts and mixtures thereof. Preferably, the curable resin is selected from the group consisting of monomers and/or oligomers of adducts of acrylate and/or methacrylate with ester, urethane, epoxy, acrylic, methacrylic and mixtures thereof. Oligomers are preferred for their lower toxicity.

Coating compositions which comprise resins curable by actinic radiation, such as ultraviolet radiation, are known in the art and are commercially available. For instance the Laromer® series of products from BASF includes epoxy acrylates, polyester acrylates, water-based acrylates, aliphatic urethane acrylates, polyether acrylates, amine/polyether acrylates and the like. The water-based commercial products are of particular use for this invention in that they are typically of low viscosity, and so are suitable for application to a yarn of a coating composition for forming a thin coating layer on the yarn. Typically, the liquid coating composition may comprise up to 99.5% by weight of curable resin, say from 30% to 99% by weight, depending upon whether it is aqueous or non-aqueous. For aqueous liquid coating compositions, the composition may comprise from 30 to 65% by weight curable resin.

The coating composition preferably further comprises a photoinitiator which absorbs actinic radiation such as ultraviolet light and initiates polymerization of the resin oligomers or monomers in the coating composition to provide solidification. Suitable photoinitiators are commercially available and include, for instance, as α-hydroxyketone, phenylglyoxate, α-aminoketone and phosphine oxide. Mixtures of photoinitiators may be used. Photonitiators are available commercially from suppliers such as BASF, e.g. Lucrin® photoinitiators or CIBA who provide Irgacure® photoinitiators.

The photoinitiator is thought to absorb actinic radiation such as UV light, generate a free radical, and cause cross-linking of functional groups on resin monomers or oligomers. Acrylate and/or methacrylate functional groups in the resin are induced to react with another functional group upon activation by a free radical, resulting in cross-linking of the monomers and/or oligomers containing the functional groups to solidify the coating layer.

A suitable level for the photoinitiator in the liquid coating composition is from 0.1% to 5% by weight of the liquid composition.

The liquid coating composition may also comprise other ingredients such as dispersants, softening agents for ensuring that the solid coating layer is flexible, antifoams to prevent or inhibit foaming during application of the coating, and the like. Typically these will be present at a level of 0.01 to 2% by weight in the liquid coating composition and suitable ingredients will be commercially available and known in the art.

Preferably, (a) the application of the liquid coating composition to form a liquid coating layer and (b) subsequent curing of the liquid coating layer with actinic radiation are carried out as sequential steps in a continuous process. By sequential, it is meant that step (b) follows step (a) in a continuous process, but this does not exclude further process steps, such as drying of the liquid coating composition being part of the continuous process, possibly interposed between steps (a) and (b). For instance, the yarn may be drawn through a coating means such as a bath or vessel holding the liquid coating composition with the coated yarn subsequently passed through a curing means, such as a region where it is illuminated with actinic radiation in order to cure the liquid coating composition into a solid coating layer on the yarn, for instance by illumination by ultraviolet lamps. Once the coating layer is in solid form, the yarn may be wound onto an uptake spool for storage prior to subsequent use or transport.

A preferred coating means for use in the method of the invention is a finish applicator such as a yarn guide comprising a dosing means for applying the coating composition to the yarn as it passes over the guide. Preferably, the liquid coating composition is applied to the yarn by direct dosing at a yarn guide, such as a ceramic yarn guide. Suitable yarn guides comprising dosing means are commercially available, for instance as Luro-Jet® finish applicators. Without wishing to be bound by theory, it is thought that the shearing of the liquid coating composition as it is applied to the yarn may lead to partial or substantial alignment of the carbon nanotubes dispersed therein (i.e. with the lengths of the carbon nanotubes substantially aligned parallel to the long axis of the yarn) and that this may lead to improved conductivity along the coating in the direction of (i.e. parallel to) the long axis of the yarn. This provides the technical benefits of good conductivity without the need to use thick coating layers, so that the resulting fabric or textile prepared from the yarn does not have its feel or handle impaired, compared to a fabric without yarns having the electroconductive coating applied thereto.

The coating composition is suitably applied to the yarn at a velocity from 1 m to 100 m/minute relative to the yarn and parallel to the yarn long axis, with the coating composition is applied in order to give a liquid coating layer having a thickness of 10 to 100 μm.

For instance, the yarn may be moved through a yarn guide applicator at a velocity from 1 m to 100 m/minute parallel to the yarn long axis with the coating composition applied in order to give a liquid coating layer having a thickness of 10 to 100 μm.

Suitably, the yarn is moved through the coating composition at a velocity from 1 to 100 m/minute, preferably from 5 to 100 m/minute, even more preferably from 10 to 100 m/minute, most preferably from 30 to 100 m/minute. The coating composition is suitably applied in order to give a liquid coating layer having a thickness of 10 to 100 μm, preferably from 15 to 75 μm, such as from 20 to 60 μm in thickness, prior to any drying step. This combination of yarn velocity and applied yarn thickness provides adequate alignment of the carbon nanotubes within the coating layer, whereby the conductivity along the length of the yarn is substantially improved (say by at least 5%) compared to direct coating of a fabric or textile yarn by conventional application at low shear, such as by using padding or the like.

In order to provide adequate shear to ensure enhancement of the conductivity through alignment of the carbon nanotubes during application of the coating layer to the yarn, the yarn is suitably fed, through a yarn guide, such as a ceramic yarn guide applicator, capable of coating the yarn as it passes through the yarn guide.

Typically, the actinic radiation used for curing the liquid coating composition is ultraviolet radiation. Preferably, the application actinic radiation for curing is applied immediately after, or contemporaneously with, coating of the yarn.

Preferably, the liquid coating composition is an aqueous composition and the coating composition is dried to substantially remove water prior to curing. By dried it is meant that the dried composition comprises less than 10% moisture by weight, preferably less than 5%, more preferably less than 1%. Liquid coating compositions in aqueous form typically have water or an aqueous solution as continuous phase with oligomer dispersed therein as droplets or particles. Such compositions may be substantially free of unreacted monomer, and this reduces the risk of unreacted monomer being present in the solid coating layer of the electroconductive yarn. Low molecular weight monomers are generally more toxic or harmful than higher molecular weight oligomers, and so the latter are preferred, particularly for textiles where skin contact is likely. Such aqueous compositions typically have a lower viscosity than non-aqueous compositions wherein the monomer and oligomer form the continuous phase.

Aqueous coating compositions are preferably dried to substantially remove water prior to curing. When the liquid coating composition is an aqueous composition the coating composition may be suitably dried to substantially remove water after step (a) and before step (b).

This may be achieved in the method of the invention by application of heat to the yarn coated with the liquid coating composition prior to curing the liquid coating composition. For instance infra-red heaters may be used to substantially remove water, for instance in a continuous process, with the heaters positioned between the coating means and the curing means as the yarn is drawn through.

The solid coating layer suitably comprises from 0.1 to 5% by weight of carbon nanotubes, preferably from 0.5 to 3% by weight.

Suitably, the solid coating layer is applied so that it has a mean thickness, when cured, of from 2 to 20 micrometres, for instance from 5 to 15 micrometres.

Carbon nanotubes for use in the invention are commercially available from suppliers such as Bayer who provide Baytubes® or Nanocyl™. Nanocyl™ NC210 and NC7000 multi-walled nanotubes having average diameters of 3.5 nm and 9.5 nm respectively (with lengths between 1 and 10 micrometres) were found to be particularly useful. Preferred carbon nanotubes are dual-walled or multi-walled nanotubes, though single walled carbon nanotubes may also be used.

The suitable and preferred features of the first aspect of the invention, as set out hereinbefore, are also applicable, when appropriate, to the other aspects of the invention as set out hereinafter. Moreover, these preferred and suitable features may be used in combinations with each other, for instance as set out in the claims of this specification.

The second aspect of the invention provides a method for forming an antistatic textile or fabric comprising:

i) forming an electroconductive yarn by the method of the first aspect of the invention, and

ii) forming the yarn into a textile or fabric.

In this specification, the terms textile and fabric are meant to be synonymous and interchangeable

The electroconductive yarn may be formed into the antistatic textile or fabric by any suitable method, for instance as a non-woven textile, but preferably by weaving or knitting.

The third aspect of the invention provides an electroconductive yarn comprising a natural or synthetic yarn having a solid coating layer coating thereon, the solid coating layer comprising a photoinitiator and polymer cured by actinic radiation and carbon nanotubes, wherein the carbon nanotubes are substantially aligned with their long axes parallel to the long axis of the yarn.

In particular, the third aspect of the invention provides an electroconductive yarn obtained or obtainable by the method of the first aspect of the invention.

The degree of alignment of the carbon nanotubes may be measured by comparing the conductivity of a layer deposited without shear (in other words, passing through the yarn guide at a velocity of 0.1 m/minute or less) that of an equivalent layer deposited whilst shear is applied (passing through the yarn guide at a velocity from 1 m/minute to 100 m/min). When the carbon nanotubes are substantially aligned, conductance for the layer, applied in a manner to provide substantial alignment of the carbon nanotubes parallel to the long axis, will be at least 5% greater than an equivalent layer deposited without shear, preferably 10% greater, more preferably 20% greater, when measured along the long axis of the yarn. This may be measured by use of surface resistivity of a fabric made from the yarn, as set out herein.

The the solid coating layer may a stripe of solid coating layer on the yarn extending along the yarn, giving the benefits of yarn flexibility combined with good conductance.

The polymer is suitably selected from the group consisting of acrylate and methacrylate adducts and mixtures thereof. Preferably, the polymer is a polymer of the group consisting of adducts of acrylate and/or methacrylate with ester, urethane, epoxy, acrylic, methacrylic and mixtures thereof.

The fourth aspect of the invention provides an antistatic textile or fabric comprising an electroconductive yarn according to the third aspect of the invention.

### EXAMPLE

Specific embodiments of the present invention will now be described, by way of example only.

A liquid coating composition was prepared from BASF® LR8949 aqueous UV-curable resin (54% by weight) and a 1% dispersion of Nanocyl™ NC7000 carbon nanotubes (Aquacyl™) with 0.45% by weight of Irgacure® 500 photoinitiator. 0.2% of antifoam (Addefoam™ AF6 supplied by CTF2000™) was also present in the composition. The ingredients were blended into a uniform dispersion for 60 minutes in an ultrasound bath. The resulting composition was 77.3% by weight water with the non-aqueous solids (i.e. the composition of the dried layer) as follows:

curable resin—96.05%

carbon nanotubes—2.00%

antifoam—0.95%

photoinitiator—2.0%

The composition was coated onto an entangled yarn (a draw textured yarn) of polyester multifilament (300 dtex/72 filaments) at a dosage level of 165 ml/hour at 100 m/min using a ceramic Luro-Jet® finish applicator and the coated yarn was passed through an infrared oven to substantially dry the coating prior to passage through an array of UV lamps to cure the coating. After curing, the coated yarn was wound onto a spool. It was found that the continuous process was operable at draw rates for the yarn from 1 m/min to 300 m/min. The resulting coating was found to have a mean thickness of 11 μm as measured by microscopy and the yarn had a surface resistivity of 10⁶ ohm compared to a value of 10¹¹ ohm for the uncoated yarn (measured with the yarn wound on a bobbin, using the Surface Resistance Meter by the method set out hereinbefore. The coating had little effect on the flexibility of the yarn as compared to the uncoated yarn.

A woven structure was made from the coated yarn prepared as set out above with a grid structure of one coated yarn every 10 mm in both directions. The woven fabric had a fabric surface resistivity of 1.16×10⁸ ohm (equivalent to the resistance measured across a square) measured according to European Standard EN 1149-1—June 2006. According to European Standard EN1149-5—January 2008, the surface resistivity should be less than or equal to 2.5×10⁹ ohm, on at least one surface, for an electrostatic dissipative material. The surface resistivity is derived from the surface resistance, is measured using the Surface Resistance Meter as set out above, in accordance with the standards set out hereinbefore.

The described and illustrated embodiments are to be considered as illustrative and not restrictive in character, it being understood that only the preferred embodiments have been shown and described and that all changes and modifications that come within the scope of the inventions as defined in the claims are desired to be protected. For instance, rather than drying the liquid coating composition with infrared radiation, the coated yarn may be passed through a thermal oven or stream of hot, dry gas to effect substantial drying of the composition prior to curing.

It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims.

1-15. (canceled)

16. A method for forming an electro-conductive yarn, the method comprising:
a) applying a liquid coating composition, comprising a resin curable by actinic radiation, to the yarn to form a liquid coating layer on the yarn, and
b) curing the liquid coating layer on the yarn with actinic radiation to form a solid coating layer on the yarn,
wherein the liquid coating composition comprises carbon nanotubes dispersed therein,
characterised in that the liquid coating composition is sheared along a direction parallel to a long axis of the yarn as it is applied to the yarn.

17. The method of claim 16 wherein the resin is selected from the group consisting of oligomers and/or monomers of acrylate and methacrylate adducts and mixtures thereof.

18. The method of claim 17 wherein the resin is selected from the group consisting of monomers and/or oligomers of adducts of acrylate and/or methacrylate with ester, urethane, epoxy, acrylic, methacrylic and mixtures thereof.

19. The method of claim 16 wherein the liquid coating composition comprises a photoinitiator.

20. The method of claim 16 wherein steps a) and b) are sequential steps in a continuous process.

21. The method of claim 16 wherein the liquid coating composition is an aqueous composition and the coating composition is dried to substantially remove water after step (a) and before step (b).

22. The method of claim 16 wherein the solid coating layer comprises from 0.1 to 5% by weight of carbon nanotubes.

23. The method of claim 16 wherein the liquid coating composition is applied to the yarn by direct dosing at a yarn guide, preferably a ceramic yarn guide.

24. The method of claim 16 wherein the coating composition is applied to the yarn at a velocity from 1 m to 100 m/minute relative to the yarn and parallel to the yarn long axis, with the coating composition is applied in order to give a liquid coating layer having a thickness of 10 to 100 μm.

25. The method of claim 16 wherein the liquid coating layer does not entirely robe the yarn whereby the solid coating layer is a stripe of solid coating layer on the yarn and extending along the yarn.

26. An electroconductive yarn comprising a natural or synthetic yarn having a solid coating layer coating thereon, the solid coating layer coating comprising a polymer cured by actinic radiation and carbon nanotubes, wherein the carbon nanotubes are substantially aligned with their long axes parallel to the long axis of the yarn.

27. The electroconductive yarn of claim 26 wherein the polymer is of oligomers and/or monomers selected from the group consisting of oligomers and/or monomers of acrylate and methacrylate adducts and mixtures thereof.

28. The electroconductive yarn of claim 27 wherein the polymer is of oligomers and/or monomers selected from the group consisting of monomers and/or oligomers of adducts of acrylate and/or methacrylate with ester, urethane, epoxy, acrylic, methacrylic and mixtures thereof.

29. The electroconductive yarn of claim 26 wherein the solid coating layer comprises a photoinitiator.

30. The electroconductive yarn of claim 26 wherein the solid coating layer is a stripe of solid coating layer on the yarn extending along the yarn.

31. The electroconductive yarn according of claim 26 wherein the electroconductive yarn is obtained or obtainable by a method comprising:
a) applying a liquid coating composition, comprising a resin curable by actinic radiation, to the yarn to form a liquid coating layer on the yarn, and
b) curing the liquid coating layer on the yarn with actinic radiation to form a solid coating layer on the yarn,
wherein the liquid coating composition comprises carbon nanotubes dispersed therein, and
wherein the liquid coating composition is sheared along a direction parallel to a long axis of the yarn as it is applied to the yarn.

32. The electroconductive yarn according to claim 31 wherein the solid coating layer is a stripe of solid coating layer on the yarn extending along the yarn.

33. An antistatic textile comprising an electroconductive yarn according to claim 26.

34. The antistatic textile of claim 33 wherein the solid coating layer is a stripe of solid coating layer on the yarn extending along the yarn.
